(19) United States
(12) Patent Application Publication
(10) Pub. No.: US 2022/0004963 A1
(43) Pub. Date: Jan. 6, 2022

(54) SYSTEM AND METHODOLOGY FOR ACCOUNT ADJUSTMENTS IN DYNAMIC LIGHTWEIGHT PERSONALIZED ANALYTICS

(71) Applicant: Sandra K. Johnson, Cary, NC (US)

(72) Inventor: Sandra K. Johnson, Cary, NC (US)

(21) Appl. No.: 17/365,080

(22) Filed: Jul. 1, 2021

Related U.S. Application Data
(60) Provisional application No. 63/047,326, filed on Jul. 2, 2020.

(51) Int. Cl. G06Q 10/06; G06Q 20/40; G06Q 20/10; G06Q 20/38

(52) U.S. Cl. CPC G06Q 10/06393; G06Q 20/389; G06Q 20/10; G06Q 20/405

(57) ABSTRACT

This invention details a feedback-based system and methodology for adjusting customer accounts in dynamic lightweight personalized analytics (DLPA). Disclosed embodiments include a process for identifying, minimizing, and leveraging the behavioral information that optimize customer financial planning results in conjunction with the key performance indicators (KPIs) used in quantifying success. It includes dynamically creating financial accounts associated with customers, as well as the real-time adjustments on the amount of funds deposited in such accounts. Furthermore, it facilitates a small memory footprint and optimal computation when making smart, customized suggestions to customers regarding their associated accounts.

### CROSS REFERENCE TO RELATED APPLICATIONS

This application claims priority to U.S. Provisional Patent Application No. 63/047,326, filed on Jul. 2, 2020, the contents of which are incorporated by reference herein in its entirety.

This application relates to U.S. application Ser. No. 17/215,750, filed Mar. 29, 2021, which claims priority to U.S. Provisional Application No. 63/000,864, filed Mar. 27, 2020, and U.S. application Ser. No. 17/194,746, filed Mar. 8, 2021, which claims priority to U.S. Provisional Application No. 62/986,754, filed Mar. 8, 2020, and U.S. application Ser. No. 17/137,677, filed Dec. 30, 2020, which claims priority to U.S. Provisional Application No. 62/922,244, filed Dec. 30, 2019, and U.S. application Ser. No. 17/084,778, filed Oct. 30, 2020, which claims priority to U.S. Provisional Application No. 62/927,872, filed Oct. 30, 2019, and U.S. application Ser. No. 17/013,895, filed Sep. 8, 2020, which claims priority to U.S. Provisional Application No. 62/897,360, filed Sep. 8, 2019, and U.S. application Ser. No. 16/914,629, filed Jun. 29, 2020, which claims priority to U.S. Provisional Application No. 62/868,950, filed Jun. 30, 2019, the contents of which are incorporated herein in their entirety.

### FIELD OF THE INVENTION

The disclosed teachings relate generally to determining the minimal set of customer behavior and other relevant information needed to optimize financial planning results in DLPA. In addition, it focuses on leveraging a small footprint to gain personalized insights used to optimize such results. Potential participants include not only those in consumer-focused industries and entities, but any entity that benefits from analytics-based suggestions for optimizing relatively small amounts of data using fast computational times.

### BACKGROUND OF THE INVENTION

Many consumer-based companies leverage customer behavior data and associated predictive, prescriptive, and other analytic methodologies to gain insights. Such information can translate into suggestions to improve efficiencies, understand trends, optimize customer objectives, create new potential markets, or discover or prevent fraud, to name a few. There is an abundance of analytics efforts conducted to gain such insights. With an increasingly consumer-centric society, there is a growing focus on behavioral analytics to understand customer preferences that can translate into market gains. Much of this work leverages a plethora of structured and unstructured data, big data, that may be siloed and geographically dispersed for insights.

There are many consumer-focused and other industries that require or benefit from small, lightweight, and fast analytics. For example, the prevailing focus in the remittance industry is the transfer of funds from sender to receiver. The transfer amounts are small, and users require minimal transfer times. Moreover, with thin industry profit margins it is important that all efforts to assist in transferring funds are efficient, lightweight, and fast. In this and many other industries, there are no significant efforts to build customer relationships, understand their preferences, needs and behaviors, and build customer loyalty leveraging small data or lightweight analytics. A study has shown that businesses that develop strong customer connections outperform their competitors by 85% in sales growth and more than 25% in gross margin.

There are some efforts to use analytics in the remittance industry. For example, current systems use analytics to understand global remittance market trends. Others use analytics to discover glitches or behavior anomalies and detect and prevent fraud. Most focus on overall trends and patterns, not individual behaviors, to gain insights for unique customer offerings. Currently, there are no efforts to develop dynamic lightweight personalized analytics methodologies to gain insights for customized services real time.

These and other drawbacks exist.

### SUMMARY OF THE INVENTION

According, one aspect of the invention is to address one or more of the drawbacks set forth above. An embodiment of the present invention is directed to a system for dynamically adjusting the creation and funding of financial accounts in dynamic lightweight personalized analytics (DLPA). The system comprises: an interface that receives one or more inputs via an enterprise payments services bus; a data store that stores and manages arrays of data structures comprising key performance indicators (KPIs), DLPA metrics and support data; and a dynamic lightweight personalized analytics engine comprising a computer processor and coupled to the data store and the interface, the computer processor configured to perform the steps of: analyzing each of sentiment data, mood data, global economic data, regional economic data, and customer milestone events to create one or more insights; receiving one or more customer parameters and remittance trends, wherein the one or more customer parameters comprise social media data, support data and communications data; accessing, via a customer account database, one or more key performance indicators (KPIs); accessing one or more DLPA metrics; wherein the DLPA metrics are impacted by one or more responses to a customer remittance suggestion; responsive to the KPI and DLPA metrics, determining whether a financial account should be created; the step of determining further comprising: incrementing the number of transactions (#trans), the cumulative transfer amount (cum_xfer_amount) and the inter-remittance frequency; comparing #trans to a transaction threshold; comparing, upon a determination that #trans is less than the transaction threshold, cum_xfer_amount to an amount threshold; comparing, upon a determination that cum_xfer_amount is less than the amount threshold, inter-remittance frequency to a frequency threshold; creating a financial account upon a determination that any one or more of the following are true: (1) #trans is not less than the transaction threshold, (2) cum_xfer_amount is not less than the amount threshold, and (3) inter-remittance frequency is not less than the frequency threshold; the creation of the financial account includes depositing a percentage of a funds transfer fee into the created account; where the percentage of the funds transfer fee is changed based on the one or more insights; and communicating, via a communication network, the account creation and the percentage of the funds transfer fee deposited into the created account.

Another embodiment of the present invention is directed to a method for dynamically adjusting the creation and funding of financial accounts in dynamic lightweight personalized analytics (DLPA). The method comprises the steps of: analyzing each of sentiment data, mood data, global economic data, regional economic data, and customer milestone events to create one or more insights; receiving one or more customer parameters and remittance trends, wherein the one or more customer parameters comprise social media data, support data and communications data; accessing, via a customer account database, one or more key performance indicators (KPIs); accessing one or more DLPA metrics; wherein the DLPA metrics are impacted by one or more responses to a customer remittance suggestion; responsive to the KPI and DLPA metrics, determining whether a financial account should be created; the step of determining further comprising: incrementing the number of transactions (#trans), the cumulative transfer amount (cum_xfer_amount) and the inter-remittance frequency; comparing #trans to a transaction threshold; comparing, upon a determination that #trans is less than the transaction threshold, cum_xfer_amount to an amount threshold; comparing, upon a determination that cum_xfer_amount is less than the amount threshold, inter-remittance frequency to a frequency threshold; creating a financial account upon a determination that any one or more of the following are true: (1) #trans is not less than the transaction threshold, (2) cum_xfer_amount is not less than the amount threshold, and (3) inter-remittance frequency is not less than the frequency threshold; the creation of the financial account includes depositing a percentage of a funds transfer fee into the created account; where the percentage of the funds transfer fee is changed based on the one or more insights; and communicating, via a communication network, the account creation and the percentage of the funds transfer fee deposited into the created account.

The computer implemented system and method described herein provide unique advantages to entities, organizations, merchants, and other users (e.g., consumers, etc.), according to various embodiments of the invention. An embodiment of the present invention is directed to identifying, minimizing, and leveraging historic customer behavior information to optimize results in dynamic lightweight personalized analytics (DLPA). The new innovative technology is designed to provide individual analytics to gain insights for developing personalized offerings to build relationships with the customer. DLPA leverages a limited number of customer specific, industry-focused input parameters, other inputs such as communications and other data, and a small footprint. These parameters are placed in data structures to assist in processing DLPA related actions. This invention focuses on dynamically adjusting the creation and funding of financial accounts in dynamic lightweight personalized analytics (DLPA) to optimize efficiencies.

These and other advantages will be described more fully in the following detailed description.

### BRIEF DESCRIPTION OF THE DRAWINGS

To facilitate a fuller understanding of the present inventions, reference is now made to the appended drawings. These drawings should not be construed as limiting the present inventions but are intended to be exemplary only.

FIG. 1 is a block diagram of a remittance payments service-oriented architecture, in accordance with exemplary embodiments of the disclosure.

FIG. 2 is a block diagram of a remittance data storage, in accordance with exemplary embodiments of the disclosure.

FIG. 3 is a block diagram of the types of data stored in a remittance data storage, in accordance with exemplary embodiments of the disclosure.

FIG. 4 is a block diagram of the partial contents of a remittance data store, in accordance with exemplary embodiments of the disclosure.

FIG. 5 is a block diagram of the dynamic lightweight personalized analytics (DLPA) engine, including customer remittance, financial and other suggestions, in accordance with exemplary embodiments of the disclosure.

FIG. 6 is a block diagram of the dynamic lightweight personalized analytics (DLPA) remittance analytics engine, including example analysis for insights and financial suggestions, in accordance with exemplary embodiments of the disclosure.

FIG. 7 is a flowchart illustrating an exemplary method for determining when to create a financial account and make an initial deposit, in accordance with exemplary embodiments of the disclosure.

FIG. 8A is a flowchart illustrating an exemplary method for adjusting when and what increased amount to deposit into the financial account, in accordance with exemplary embodiments of the disclosure.

FIG. 8B is a flowchart illustrating a continuation of the exemplary method for adjusting when and what decreased amount to deposit into the financial account, in accordance with exemplary embodiments of the disclosure.

### DETAILED DESCRIPTION OF THE PREFERRED EMBODIMENT(S)

The following description is intended to convey an understanding of the present invention by providing specific embodiments and details. It is understood, however, that the present invention is not limited to these specific embodiments and details, which are exemplary only. It is further understood that one possessing ordinary skill in the relevant art, considering known systems and methods, would appreciate the use of the invention for its intended purposes and benefits in any number of alternative embodiments, depending upon specific design and other needs.

An embodiment of the present invention is directed to identifying, minimizing, and leveraging historic customer behavior information to optimize results in dynamic lightweight personalized analytics (DLPA). Specifically, it is used to suggest or dynamically adjust financial or other account information associated with the customer. DLPA is a new innovative technology designed to provide individual analytics to gain insights for developing personalized offerings to build relationships with the customer. DLPA leverages a limited number of customer-specific, industry-focused input parameters, other inputs such as financial and other data, and a small footprint. These parameters are placed in data structures to assist in processing DLPA-related actions. This invention focuses on dynamically adjusting the creation of accounts, funds deposited into financial accounts and other similar metrics used in DLPA to optimize efficiencies.

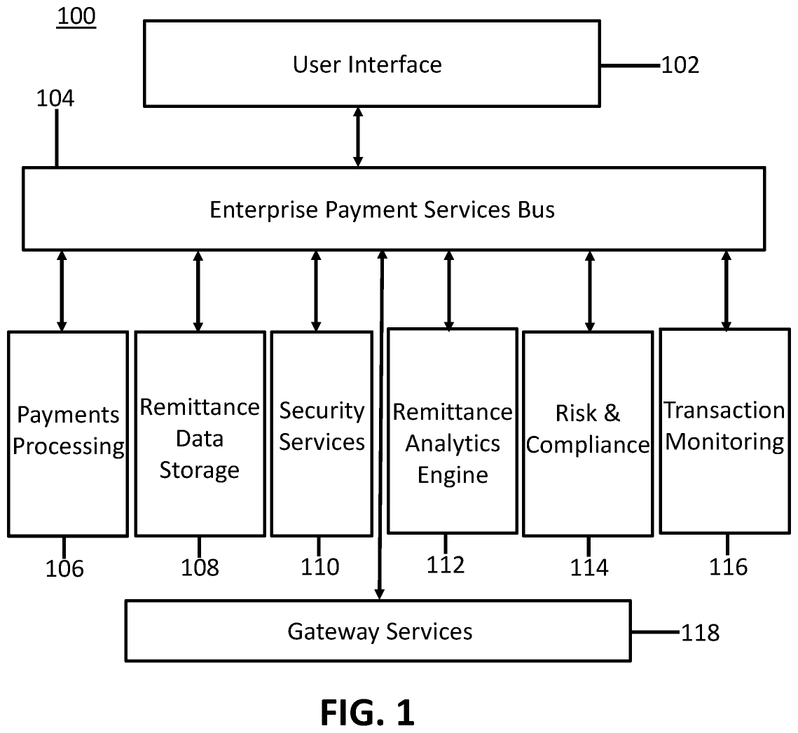

FIG. 1 is a schematic block diagram illustrating one embodiment of the service-oriented architecture (SOA) 100 of a remittance system designed to process transactions, in accordance with one embodiment of the present invention. The system 100, in one embodiment, includes a user interface 102 that enables a user to send or receive requests, etc. This user interface 102 interacts with the enterprise payments services bus 104 to request and/or receive services. The enterprise payments services bus 104 may be configured to transmit data between engines, databases, memories, and other components of the system 100 for use in performing the functions discussed herein.

The enterprise payments services bus 104 may include one or more communication types and utilize various communication methods for communications within a computing device. For example, the enterprise payments services bus 104 may include a bus, contact pin connectors, wires, etc. In some embodiments, the enterprise payments services bus 104 may also be configured to communicate between internal components of system 100 and external components accessible through gateway services 118, such as externally connected databases, display devices, input devices, etc.

There are several services that may compose this SOA 100, including payments processing 106, remittance data storage 108, security services 110, the remittance analytics engine 112, risk and compliance 114, transaction monitoring 116, and gateway services 118, which are described below. Each of these service components may be software, a computer-readable program, executing on one of more processors and may include a mainframe computer, a workstation, a desktop computer, a computer in a smart phone, a computer system in a rack, a computer system in a cloud, a physical system, a virtual system, and the like.

The system 100, in one embodiment, is the SOA of a remittance system and is a network of software service components in which the illustrative embodiments may be implemented. The system 100 includes a user interface 102 used by a consumer. The consumer represents a person, a software program, a virtual program, or any other entity that has possession of, can emulate, or otherwise issue commands to execute transactions in the system 100. The system 100 includes an enterprise payment services bus 104 which accepts and processes commands from the user interface 102 and other system components. It also enables communication among the various services components in the system 100.

As a part of executing a remittance request, the transaction may leverage payments processing 106 to process the request. Such processing may also include the creation and funding of financial accounts associated with a recipient. The transaction may also access remittance data storage 108 which is a resource for data access. Security services 110 are also leveraged to ensure the full security and integrity of funds and data, and to detect and prevent fraud. In addition, the remittance analytics engine 112 may be leveraged and serve as the foundation for DLPA. This engine takes as input a plethora of information from the remittance data storage 108 and other components that may enable the remittance analytics engine 112 to optimize its outputs. The risk and compliance service 114 may provide customer identification, verification and other similar services to comply with relevant governmental regulations and to minimize risk. The transaction monitoring 116 service tracks funds transfer behavior and other activities to detect anomalies that may point to fraud. It works in concert with security services 110.

Gateway services 118 enable the transfer of funds, data, requests, etc. to externally connected entities for further processing. Such entities may include a computer network, a financial institution, and others that may participate in end-to-end remittance or other funds transfer or data services. Other similar embodiments will be apparent to persons having skill in the relevant art.

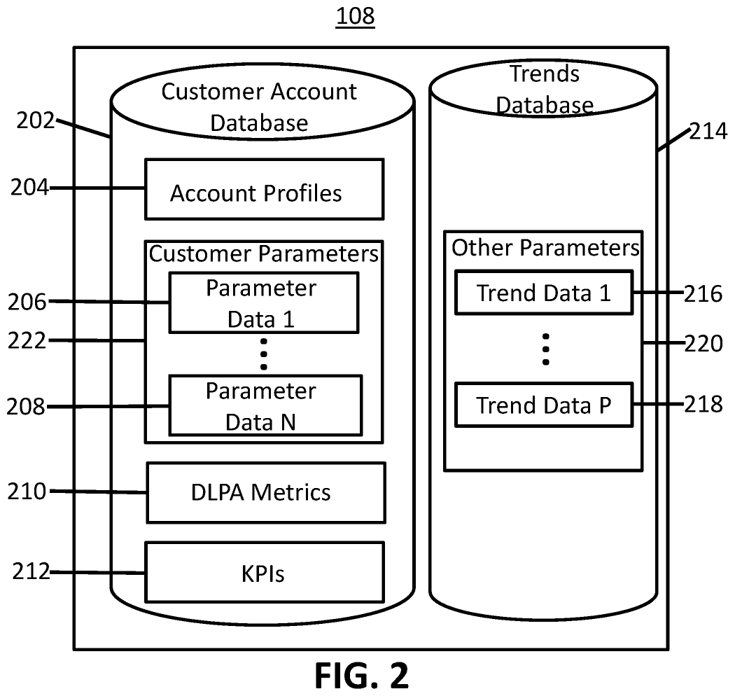

FIG. 2 is a schematic block diagram illustrating one embodiment of the remittance data storage service 108 used in the processing of information requests. The remittance data storage 108 may represent a relational database, or a collection of relational databases, that utilizes structured query language for the storage, identification, modifying, updating, accessing, etc. of structured data sets stored therein. This data storage 108 may include a customer account database 202 that contains customer account and other related customer information. The customer account database 202 may be configured to store a plurality of consumer account profiles 204 as well as a plurality of customer parameter data 222, for customers 206 and 208, using a suitable data storage format and schema.

Each customer account profile 204 may be a structured data set configured to store data related to a remittance account. Each customer account profile 204 may include at least the customer's full name, address, telephone number, birthdate, birth country, a remittance account number, a bank account number, credit card account information, email address, a list of recipients and associated international mobile telephone numbers, remittance transaction history, a postal mailing address, an email address, and other relevant information. The customer account profile 204 may also include additional information suitable for customer service programs, customer and vendor optimizations, and regulations, such as product data, offer data, loyalty data, reward data, usage data, currency-exchange data, mobile money data, fraud scoring, validity of funds, and transaction/account controls. The customer account profile 204 may also include additional information that may be required for know-your-customer (KYC) and anti-money laundering (AML) regulations. It may further contain information suitable for performing the functions discussed herein, such as communication details for transmitting via the enterprise payment services bus 104.

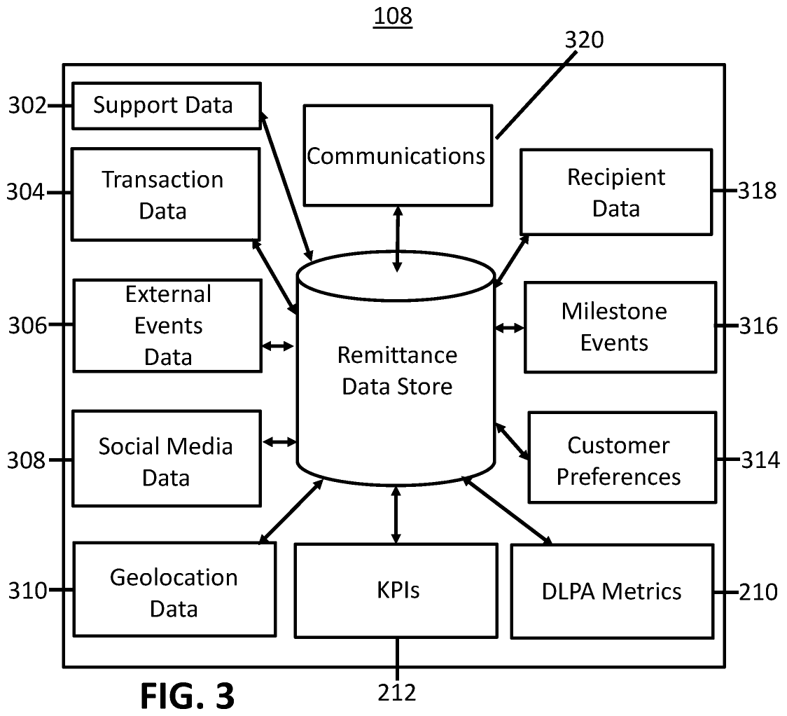

The customer parameter data 206 and 208 may be a wealth of various types or facts or other data (see FIG. 3) about the customer. Example parameter data may include the number and type(s) of financial accounts associated with the customer's recipients, the associated account balances, recommendation acceptance rate (RAR), recommendation impact (RI), recommendation acceptance impact (RAI), financial account acceptance rate (FAR), financial recommendation impact (FRI), financial recommendation acceptance impact (FAI), other recommendation rate (OAR), other recommendation impact (ORI) or other recommendation acceptance impact (ORI). The data may be a component of the trend data 214 that is potentially used as input or output information for the remittance analytics engine 112.

Also contained in the customer account database 202 are other parameters 220, which include parameter and trend data 216 and 218. Examples of other parameters 220 include the LG-Mix, transaction data, customer temperament information, external events, social media data, geolocation data, communications data, recipient data, and milestone events. This data also includes OP-Max, the maximum number of other parameters 220 considered per customer, and OP-Count-Trigger, used to determine when to remove or replace other parameters 220. OP-Max also represents the size of the other parameter 220 array per customer. Both OP-Max and OP-Count-Trigger are default parameters that may be adjusted dynamically. Furthermore, the customer account database 202 may include DLPA metrics 210 designed to quantify success and key performance indicators (KPIs) 212.

Example KPIs 212 are listed below in paragraphs 41 and 59. Some include the total funds transferred per customer, the total number of transfers per customer, the total number of recipients per customer and the total balances in all financial accounts per customer.

FIG. 3. represents a schematic block diagram illustrating one embodiment of specifics regarding the plurality of data that may be stored in the remittance data storage 108. This data may be stored as structured data sets that may include support data 302, transaction data 304, external events data 306, social media data 308, geolocation data 310, KPIs 212, DLPA metrics 210, customer preferences 314, milestone events 316, recipient data 318 and communications data 320.

Example support data 302 include the type of support inquiry, how it was resolved, response time, resolution time, frequency of support contact, customer satisfaction data and other similar metrics. Example transaction data 304 may include the transfer amount, transfer time, recipient name and international mobile number, the time period since the last transfer initiated by the sender to any receiver, the time period since the last transfer initiated by the sender to a specific receiver, and the final status of a transaction (e.g., completed, cancelled, etc.). Additional data may include metrics to quantify customer sentiments such as the number of times or frequency that the customer contacted support, time with support, and support outcomes. Example external events data 306 include general remittance transaction data (e.g., transfer amounts, frequency, etc.) for other customers using the specific remittance service or for remittance customers using any remittance service, public holidays for the sender and receiver countries, natural disasters, immigration policies, the price of oil, global and local recessions.

Example social media data 308 may include posts and other exchanges in Facebook, Twitter, Instagram, LinkedIn, and other similar social media platforms. Example geolocation data 310 may include the physical location of the sender and receiver when the funds transfer is initiated or received or the physical location of the sender or receiver at specific or random times. Other similar embodiments will be apparent to persons having skill in the relevant art.

Example customer preferences 314 are from the perspective of the sender. They may include hobbies, favorite things to do and financial preferences. Furthermore, LPA enables the creation of a financial or other count by the customer to save for the future. This account may be created and funded either statically or dynamically. A customer preference 314 may include the customer's desire to create a separate account (or some other activity) based on DLPA analytics, to choose the type of account to create and to determine how to fund the account.

A customer preference 314 may be to create a financial or other account when registering for the remittance service, or upon DLPA recommendations when using the remittance service. Such an account may be targeted for the customer's remittance recipients. A customer may select between a checking, savings, money market, brokerage, or other similar account. The customer may choose the purpose for creating a bank account (e.g., for education, starting a business, donating to a charity or some other option for the sender and/or the receiver). The choices may be general (e.g., the same type of account for sender and each recipient), for each recipient, or variable (e.g., a different type of account depending on the recipient or a group of recipients). In addition, the customer may choose to change the account type, the deposit amounts, and the number of accounts dynamically or statically per recipient. Other similar embodiments will be apparent to persons having skill in the relevant art.

Example milestone events 316 may include birthdays, including milestone birthdays (e.g., 18, 25, 30, etc.), weddings, anniversaries, graduations, and other special days for the sender or receiver. Example recipient data 318 may include full name, international telephone number and recipient preferences that are like customer preferences 314. Communications data 320 may include the recent types of communications between sender, receiver, the remittance service provider, and external entities. This includes SMS messages, email, and communication types. Other similar embodiments will be apparent to persons having skill in the relevant art.

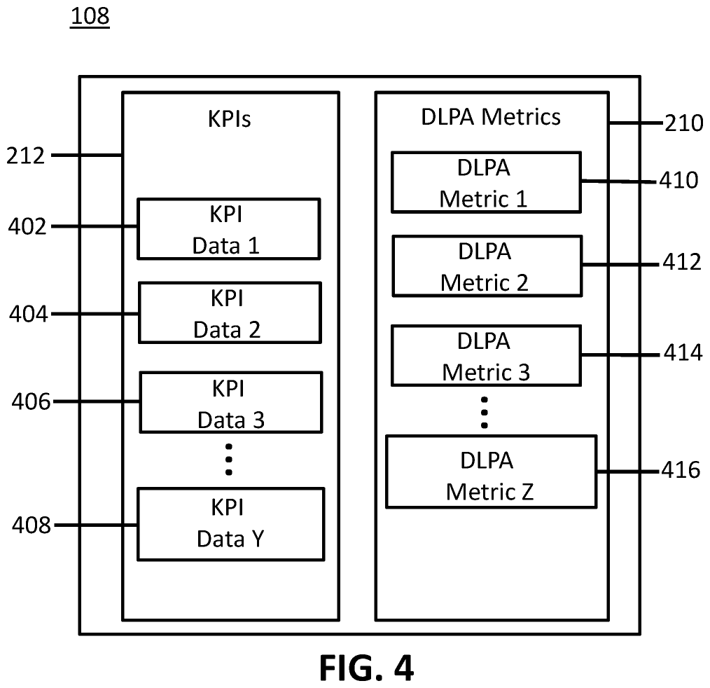

FIG. 4 108 is a schematic block diagram illustrating one embodiment of partial contents of the remittance data storage that contains arrays of KPIs 212 and DLPA metrics 210. There is a plurality of KPIs 212: 402, 404, 406, and 408, contained in the remittance data storage 108. Also illustrated is a plurality of DLPA metrics 210: 410, 412, 414, and 416. These metrics may be contained in the remittance data storage 108. Representative KPIs 212 may include KPI-Max, the maximum number of KPIs 212 considered per customer and KPI-Count-Trigger, used to determine when to remove or replace a KPI 212. KPI-Max also represents the size of the KPI 212 array per customer. Both KPI-Max and KPI-Count-Trigger may be adjusted dynamically, as detailed in U.S. Provisional Patent Application No. 62/927,872, the contents of which are incorporated by reference herein in their entirety. Included in the DLPA metrics 210 is DLPA-Max, the maximum number of DLPA metrics 210 considered per customer and DLPA-Count-Trigger, used to determine when to remove or replace a DLPA metric 210. DLPA-Max also represents the size of the DLPA 210 array per customer. Both DLPA-Max and DLPA-Count-Trigger are adjusted dynamically, as detailed in U.S. Provisional Patent Application No. 62/927,872, the contents of which are incorporated by reference herein in their entirety.

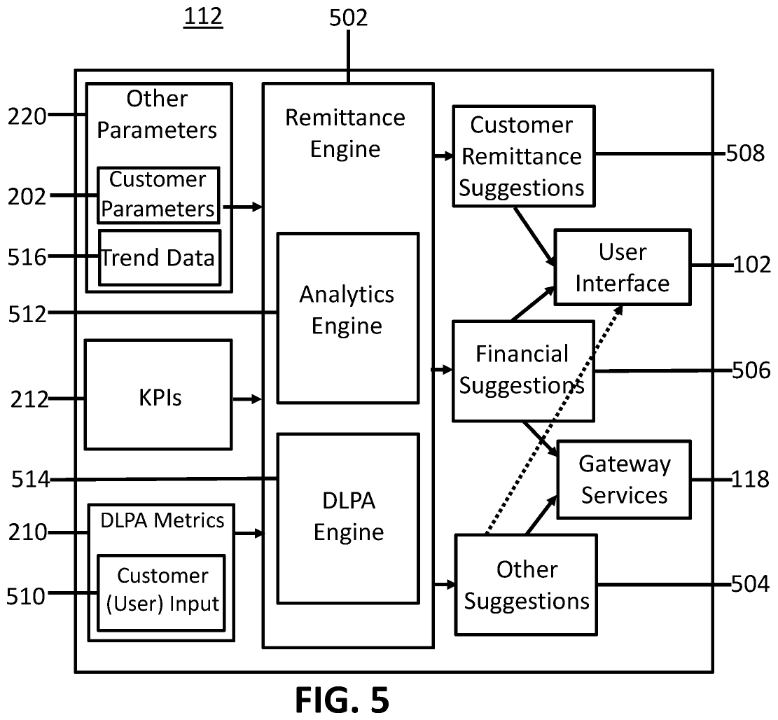

FIG. 5 is a schematic block diagram illustrating one embodiment of the remittance analytics engine 112, the foundation for DLPA. It includes at its core the remittance engine 502, which contains the analytics engine 512, and the DLPA engine 514. The remittance engine 502 accepts customer parameters 222 and trend data 516 as input. Examples of remittance trend data include average remittance amounts over all customers, remittance frequencies and time frames, remittance geographies, remittance increases over holidays or special occasions, and other similar metrics. Customer parameters 222 may include social media 308, support 214, and communications data 320 as well as other data. They collectively form the other parameters 220 set of inputs. Other input metrics include the KPIs 212. The DLPA engine 514 processes DLPA related events. It accepts DLPA metrics 210. The DLPA metrics 210 are impacted by responses to customer remittance suggestions 508. Such responses are contained in the customer input data 510, a component of the DLPA metrics 210. Outputs for the remittance engine 502 include customer remittance suggestions 508, financial suggestions 506 and other suggestions 504.

The customer remittance suggestions 508, financial suggestions 506 and other suggestions 504 may communicate their suggestions to the customer through the user interface 102. In addition, the financial suggestions 506 and other suggestions 504 may communicate their suggestions to external entities (e.g., banks) via gateway services 118.

The remittance engine 502 may represent a primary computational engine for leveraging predictive, customer behavioral and other analytics techniques for optimal customer remittance suggestions 508, financial suggestions 506 and other suggestions 504 for DLPA. It further utilizes a plurality of customer parameters 222, including social media 308, support 302, and communications data 320, remittance trends 214, KPIs 212 and DLPA metrics 210 as input for its calculations. Some of the DLPA metrics 210 associated with remittance suggestions may include the recommendation ratio (RR) and the financial recommendation ratio (FRR). RR represents the ratio of the number of suggested remittances to the total number of remittances, suggested and traditional. FRR represents the ratio of the total suggested remittance amounts to the total funds in remittance accounts.

Customer remittance suggestions 508 may include recommendations for sending additional funds to one or a plurality of recipients, increasing the frequency of sending funds to one or a plurality of recipients, or other similar suggestions. Moreover, the customer may agree to specific transfer amounts and frequency, based on certain analytics triggers, upon customer registration, by default or dynamically. Financial suggestions 506 may include creating one or a plurality of finance accounts, based on customer preferences 314. The type and number of accounts may be determined upon customer registration for the remittance service, by default, or dynamically. The number, type, or frequency of other suggestions 504 may be determined in a similar manner.

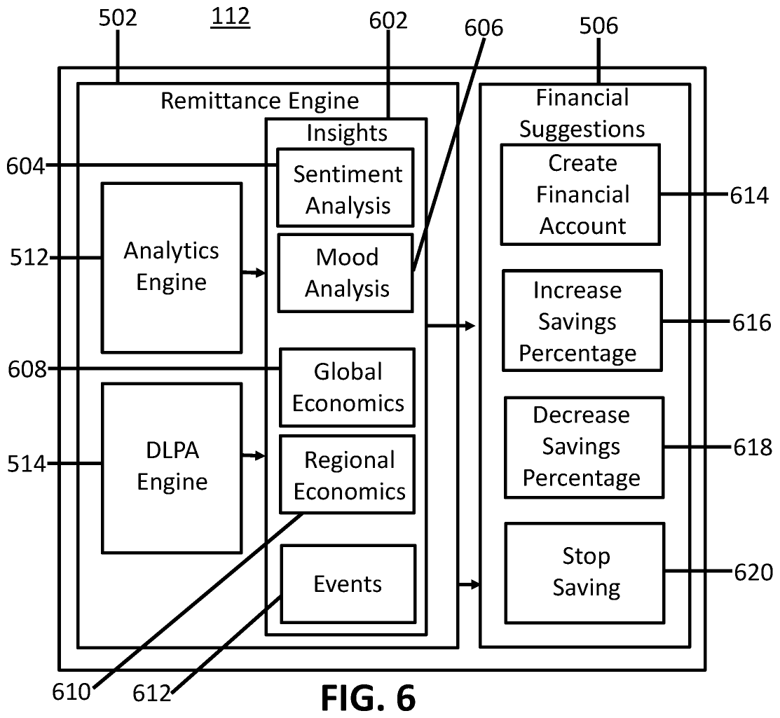

FIG. 6 112 is a schematic block diagram illustrating an exemplary method for the remittance analytics engine 112. It includes the core remittance engine 502, which includes the analytics engine 512 and the DLPA engine 514. In addition, it includes insights 602 obtained from sentiment analysis 604, mood analysis 606, global economic data 608, regional economic data 610 and other events 612, such as customer milestone events 316. Other embodiments may show other similar analysis methods for assessing customer behavior or mood, as well as other external factors impacting financial account behavior.

These insights 602 are then provided as input in the remittance engine 502 to provide financial suggestions 506 to the customer. Exemplary suggestions 506 include creating a financial account 614, increasing 616 or decreasing 618 the percentage of the funds transfer fee to deposit into the account or stop adding funds to the account 620.

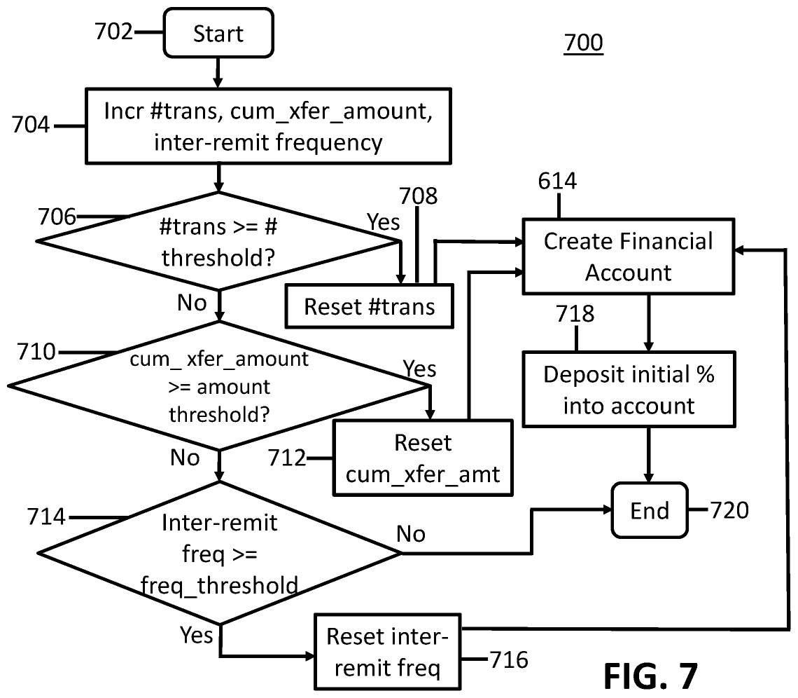

FIG. 7 700 is a flowchart illustrating an exemplary method for determining whether to initially suggest or create a financial account and make an initial deposit into the account. The method starts 702 by incrementing several parameters, including the number of transactions (#trans), the cumulative transfer amount (cum_xfer_amount) and the inter-remittance frequency 704. (These parameters are initially reset to 0). The number of transactions is the total number of remittances sent by the customer since the last time the number was set. This number may be incremented once per customer transfer (independent of the intended recipient) or once for transfers from the customer to a specific receiver. cum_xfer_amount is the cumulative sum of the amount of funds transferred since this parameter was last set. Like #trans, this number can be per customer, independent of the number of recipients, or for each customer-recipient pair. The inter-remittance frequency is the number of remittances, per customer or per customer-recipient pair, since the parameter was last reset.

Once these parameters are incremented 704, the method checks whether #trans is greater than or equal to a transaction threshold (# threshold) 706. # threshold is set as a default value or by the customer (for all recipients or per recipient). If yes, then #trans is reset 708 and the financial account is created 614. If no, then the method checks whether cum_xfer_amount is greater than or equal to a threshold amount (amount threshold) 710. Amount threshold is set as a default value or by the customer (for all recipients or per recipient). If yes, then cum_xfer_amount is reset 712 and the financial account is created 614. If no, then the method checks to determine if inter-remit frequency is greater than or equal to a frequency threshold, freq threshold 714.

Freq threshold is set as a default value or by the customer (for all recipients or per recipient). If yes, then inter-remit frequency is reset 716 and the financial account is created 614.

Once the financial account is created 614 and initial deposit is made to the account 718. The amount is equal to the initial percentage of the transfer fee, which is set as a default or by the customer. The percentage can be the same for all recipients or separate for each customer-recipient pair. This ends 720 the method for initially creating a financial account 614.

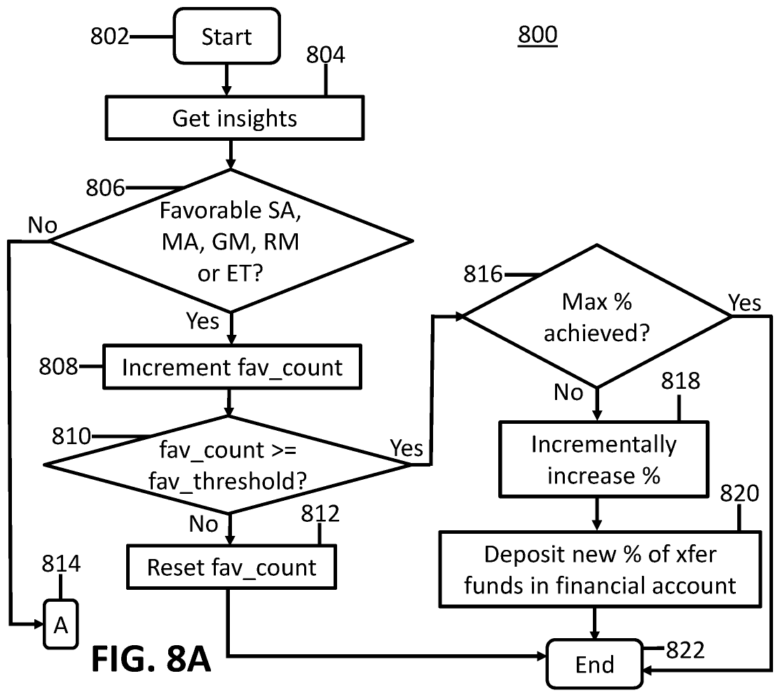

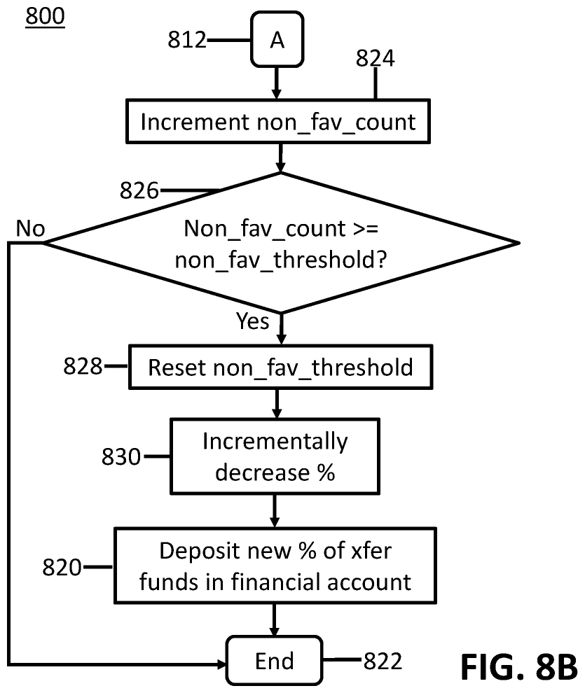

FIG. 8A 800 is a flowchart illustrating an exemplary method for determining when to dynamically increase the percentage of the funds transfer fee to deposit into the financial account. The method starts 802 by obtaining the insights 804 from the remittance analytics engine 112. These insights are obtained via sentiment analysis (SA) 604, mood analysis (MA) 606, global economics (GM) 608, regional economics (RA) 610 or events (ET) 612.

If at least one of them is favorable 806, then fav_count is incremented 808. fav_count is the number of times at least one of these factors is favorable for a customer. Next, if fav_count is greater than or equal to fav_threshold 810 (yes), then the method determines if the maximum percentage of funds transferred allowed to be deposited into the financial account (max %) has been reached 816. Max % is either set as a default or by the customer. If no, then fav_count is reset 812 and the method ends 822.

If max % has been achieved 816 (yes), then the method ends 822. If not, then the percentage of the funds transfer fee to be deposited into the financial account is increased incrementally 818 and this new percentage of funds are deposited into the account 820. The method then ends 822.

If fav_count is not greater than fav_threshold 810 (no), then the method moves to the next step (A) 814 in FIG. 8B.

FIG. 8B 800 is a flowchart illustrating an exemplary method for determining when to dynamically decrease the percentage of the funds transfer fee to deposit into the financial account. Initially 812 the method increments non_fav_count 824. This parameter counts the number of times a remittance transaction results in non-favourable insights 602 from the analytics engine 112. If non_fav_count is great than or equal to non_fav_threshold 826, then it is reset 828. Non fav_threshold is set as a default or by the customer. It is used as a trigger to determine when to adjust the percentage of the customer funds transfer fee should be deposited into the financial account.

After non_fav_threshold is reset 828, then the percentage is incrementally decreased 830. Next, the funds to be deposited into the financial account are calculated based on the new % and deposited 820. The method then ends 822.

All the parameters described here are either initially set to a default value or set by the customer. Where relevant, it may be a single value per customer, independent of the number of recipients, or it may be different variables and values for each customer-recipient pair. Such options are familiar to those skilled in the art.

DLPA Metrics may represent parameters used in DLPA methodology. Exemplary metrics may include the following:
RAR: recommendation acceptance rate; the fraction of all recommendations per customer accepted
RI: recommendation impact; the fraction of all recommendations resulting in an increase in at least one KPI (new KPI value >=current KPI value) in KPI-Array
RAI: acceptance impact; the fraction of all customer accepted recommendations resulting in an increase in at least one KPI in KPI-Array
FAR: financial account acceptance rate; the fraction of all financial account recommendations per customer accepted
FRI: financial recommendation impact; fraction of all financial account recommendations resulting in an increase in at least one KPI in KPI-Array
FAI: finance recommendation acceptance impact; fraction of all accepted financial account recommendations resulting in an increase in at least one KPI in KPI-Array
OAR: other recommendations acceptance rate; the fraction of all other recommendations per customer accepted
ORI: other recommendations impact; fraction of all non-financial-account recommendations resulting in an increase in at least one KPI in KPI-Array
OAI: other recommendations acceptance impact; fraction of all accepted non-financial-account recommendations resulting in an increase in at least one KPI in KPI-Array
RR: Recommendation Ratio is a ratio of the number of suggested remittances to the total number of remittances (suggested plus traditional)
FRR: Financial Recommendation Ratio is a ratio of the total suggested remittance amounts in accounts to the total number of funds in accounts
Rec-Array: an array of past recommendations to the customer, including the type of recommendation (e.g., financial, or other), and whether accepted
Rec-Array-Max: the maximum number of entries in the Rec-Array
CIS: Change in Savings is the change in the total savings amounts per customer, or per recipient per customer, between time windows.
DLPA-Array: a collection the DLPA metrics of focus per customer, and whether it favorably impacted each KPI per customer
DLPA-Count-Trigger: used to determine when to remove or replace a DLPA metric
DLPA-Max: the maximum number of DLPA metrics considered per customer
REMOVE: a flag to determine whether to remove or replace a DLPA metric in DLPA-Array

Key Performance Indicators (KPIs) may be stored as an array of data and may include the following:
TFT: Total funds transferred per customer (sender)
TFT-Min: the minimum value for TFT
TNT: Total number of transfers per customer
TB: Total balances in all financial accounts per customer
TB-Min: the minimum value for TB
NR: Total number of recipients per customer
NFA: Total number of financial accounts per customer
KPI-Array: a collection the KPIs of focus per customer
KPI-Max: the maximum number of KPIs considered per customer
KPI-Count-Trigger: used to determine when to remove or replace a KPI

LG-Mix may represent a fraction of all DLPA suggestions (local and global) that are local.

Other Parameters may include DLPA parameter and trend data described in U.S. Provisional Patent Application No. 62/868,950, the contents of which are incorporated herein in their entirety.

Examples include the LG-Mix, transaction data, external events, social media data, geolocation data, communications data, recipient data, milestone events, trend data, etc.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed sequentially, concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Many of the functional units described in this specification have been labelled as modules, to emphasize their implementation independence more particularly. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

What is claimed is:

1. A system for dynamically adjusting the creation and funding of financial accounts in dynamic lightweight personalized analytics (DLPA), the system comprising:
an interface that receives one or more inputs via an enterprise payments services bus;
a data store that stores and manages arrays of data structures comprising key performance indicators (KPIs), DLPA metrics and support data; and
a dynamic lightweight personalized analytics engine comprising a computer processor and coupled to the data store and the interface, the computer processor configured to perform the steps of:
analyzing each of sentiment data, mood data, global economic data, regional economic data, and customer milestone events to create one or more insights;
receiving one or more customer parameters and remittance trends, wherein the one or more customer parameters comprise social media data, support data and communications data;
accessing, via a customer account database, one or more key performance indicators (KPIs);
accessing one or more DLP A metrics; wherein the DLPA metrics are impacted by one or more responses to a customer remittance suggestion;
responsive to the KPI and DLPA metrics, determining whether a financial account should be created; the step of determining further comprising:
incrementing the number of transactions (#trans), the cumulative transfer amount (cum_xfer_amount) and the inter-remittance frequency;
comparing #trans to a transaction threshold;
comparing, upon a determination that #trans is less than the transaction threshold, cum_xfer_amount to an amount threshold;
comparing, upon a determination that cum_xfer_amount is less than the amount threshold, inter-remittance frequency to a frequency threshold;
creating a financial account upon a determination that any one or more of the following are true: (1) #trans is not less than the transaction threshold, (2) cum_xfer_amount is not less than the amount threshold, and (3) inter-remittance frequency is not less than the frequency threshold; the creation of the financial account includes depositing a percentage of a funds transfer fee into the created account;
where the percentage of the funds transfer fee is changed based on the one or more insights; and
communicating, via a communication network, the account creation and the percentage of the funds transfer fee deposited into the created account.

2. The system of claim 1 where #trans is the total number of remittances sent by the customer and is incremented once per customer transfer.

3. The system of claim 1 where cum_xfer_amount is the cumulative sum of the amount of funds transferred.

4. The system of claim 1 where the inter-remittance frequency is the number of remittances per customer.

5. The system of claim 1 where an initial percentage of the funds transfer fee is set by a customer.

6. The system of claim 1 where the percentage of the funds transfer fee is increased based a determination that at least one of the one or more insights is favorable.

7. The system of claim 6 where the funds transfer fee is increased further based on a determination that a summation of the favorable insights exceeds a favorable insight threshold.

8. The system of claim 1 where the percentage of the funds transfer fee is decreased based a determination that at least one of the one or more insights is non-favorable.

9. The system of claim 8 where the funds transfer fee is decreased further based on a determination that a summation of the non-favorable insights exceeds a non-favorable insight threshold.

10. A method for dynamically adjusting the creation and funding of financial accounts in dynamic lightweight personalized analytics (DLPA), the method comprising the steps of:
analyzing each of sentiment data, mood data, global economic data, regional economic data, and customer milestone events to create one or more insights;
receiving one or more customer parameters and remittance trends, wherein the one or more customer parameters comprise social media data, support data and communications data;
accessing, via a customer account database, one or more key performance indicators (KPIs),
accessing one or more DLPA metrics; wherein the DLPA metrics are impacted by one or more responses to a customer remittance suggestion;
responsive to the KPI and DLPA metrics, determining whether a financial account should be created; the step of determining further comprising:
incrementing the number of transactions (#trans), the cumulative transfer amount (cum_xfer_amount) and the inter-remittance frequency;
comparing #trans to a transaction threshold;
comparing, upon a determination that #trans is less than the transaction threshold, cum_xfer_amount to an amount threshold;
comparing, upon a determination that cum_xfer_amount is less than the amount threshold, inter-remittance frequency to a frequency threshold;
creating a financial account upon a determination that any one or more of the following are true: (1) #trans is not less than the transaction threshold, (2) cum_xfer_amount is not less than the amount threshold, and (3) inter-remittance frequency is not less than the frequency threshold; the creation of the financial account includes depositing a percentage of a funds transfer fee into the created account;
where the percentage of the funds transfer fee is changed based on the one or more insights; and
communicating, via a communication network, the account creation and the percentage of the funds transfer fee deposited into the created account.

11. The method of claim 10, where #trans is the total number of remittances sent by the customer and is incremented once per customer transfer.

12. The method of claim 10, where cum_xfer_amount is the cumulative sum of the amount of funds transferred.

13. The method of claim 0, where the inter-remittance frequency is the number of remittances per customer.

14. The method of claim 10, where an initial percentage of the funds transfer fee is set by a customer.

15. The method of claim 10, where the percentage of the funds transfer fee is increased based a determination that at least one of the one or more insights is favorable.

16. The method of claim 15, where the funds transfer fee is increased further based on a determination that a summation of the favorable insights exceeds a favorable insight threshold.

17. The method of claim 10, where the percentage of the funds transfer fee is decreased based a determination that at least one of the one or more insights is non-favorable.

18. The method of claim 17, where the funds transfer fee is decreased further based on a determination that a summation of the non-favorable insights exceeds a non-favorable insight threshold.
